(19) United States
(12) Patent Application Publication
(10) Pub. No.: US 2017/0106826 A1
(43) Pub. Date: Apr. 20, 2017

(54) SEAT OCCUPANCY SENSOR

(71) Applicant: IEE INTERNATIONAL ELECTRONICS & ENGINEERING S.A., Echternach (LU)

(72) Inventors: Christophe KEISER, Berg (LU); Wade QI, Beijing (CN)

(21) Appl. No.: 15/127,018

(22) PCT Filed: Mar. 5, 2015
(86) PCT No.: PCT/EP2015/054635

§ 371 Date: Sep. 17, 2016

(30) Foreign Application Priority Data
Mar. 17, 2014 (LU) LU 92 400

(51) Int. Cl. B60R 21/015; G01L 1/22; B60N 2/00

(52) U.S. Cl. CPC B60R 21/01516; B60N 2/002; G01L 1/2287

(57) ABSTRACT

A sensor arrangement, as e.g. a seat occupancy sensor, comprises at least two terminals for connecting said sensor assembly to a control unit, and a first switching group of at least two switching units, said at least two switching units of said first switching group being connected together in such a way as to implement a first logical AND gate. According to the invention the sensor arrangement further comprises at least one second group of at least two switching units, wherein said at least two switching units of said second switching group are connected together in such a way as to implement a second logical AND gate and wherein said first switching group and said at least one second switching group are connected together in such a way as to implement a logical OR gate.

### TECHNICAL FIELD

The present invention generally relates to the technical field of seat occupancy sensors, especially for use in recognition of seat occupancy in a motor vehicle.

### BACKGROUND ART

Seat occupancy sensors are nowadays commonly used in automotive vehicles in order to improve the efficiency of secondary seat restraint systems, such as e.g. the vehicle airbags or the seat belt pretension systems. The seat occupancy sensors usually comprise a plurality of individual switching elements, which are arranged in an array configuration and associated to a seating surface of the vehicle seat. The individual switching elements are typically configured as pressure sensors, e.g. force sensing resistors, in which an electrical resistance is depending on the force acting on the seat.

In a possible application of those seat occupancy sensors, an actual seat occupancy status is determined by means of the seat occupancy sensors and, in case of a car crash situation, the airbags associated with the respective seat are deployed only if the actual seat occupancy status requires such deployment. It is clear that this application is safety critical and as such requires rather complex occupancy sensors and evaluation units to ensure that misclassifications of the seat occupancy are excluded.

In a different application, the signal of the seat occupancy sensor is used in a seat belt warning system for generating a warning signal if a specific vehicle seat is occupied and the corresponding seat belt is not fastened. This application is not safety critical as such and therefore an exact assessment and classification of seat occupancy is not essential. For this type of non safety-critical applications it is desirable to provide a less complex seat occupancy sensor and/or evaluation unit.

For seat belt reminder applications, it is desirable that the occupancy sensor must basically be capable of distinguishing between seat occupancy by a passenger and occupancy by some object, such as a handbag. For this application, a more complex costly classification of seat occupancy is not needed.

A seat occupancy sensor for seat belt reminder systems of this kind has been proposed in EP application EP 1 636 071. The seat occupancy sensor disclosed in this document comprises at least two pressure activatable switching elements which are arranged on either side of the centreline of the seat such that a first switching element is associated to the left side of the seat and a second switch element is associated to the right side of the seat. The first and second switching elements are interconnected in such a way as to form a logical AND gate. In a especially simple embodiment of the invention, the first and second switching elements are connected in series between terminals of the occupancy sensor.

Due to the AND gate connection of the first and second switching elements, a signal from the two elements can only be measured when both switching elements are actuated by a corresponding occupancy of the seat. Accordingly occupancy of the seat is only detected as such if both switching elements are actuated simultaneously by an occupant and seat occupancy will only be recognized as such if the occupancy of the seat extends over both sides of the seat. Unilateral actuation of the seat occupancy sensor, for example due to the presence of an object such as a handbag placed on one side of the seat, will not be recognized as seat occupancy and the seat belt warning system will consequently not respond.

The above described seat occupancy sensor enables a reliable discrimination between a localized occupancy, which only triggers a single one of the two switching elements, and occupancy spanning over both sides of the seat, which triggers both switching elements, with a very simple evaluation unit. However this sensor does not enable discrimination of more complex seat occupancy pattern or profiles.

### Technical Problem

It is an object of the present invention to provide an improved seat occupancy sensor. The object is achieved by the invention as claimed in claim 1.

### General Description of the Invention

A sensor arrangement, as e.g. a seat occupancy sensor, in accordance with the present invention comprises at least two terminals for connecting said sensor assembly to a control unit, and a first switching group of at least two switching units, said at least two switching units of said first switching group being connected together in such a way as to implement a first logical AND gate. According to the invention the sensor arrangement further comprises at least one second group of at least two switching units, wherein said at least two switching units of said second switching group are connected together in such a way as to implement a second logical AND gate and wherein said first switching group and said at least one second switching group are connected together in such a way as to implement a logical OR gate.

As a result of the at least two switching units of the first switching group being connected in order to form a logical AND gate, an activation of said first switching group is only considered when all the switching units of the first switching group are activated. Likewise an activation of said second switching group is only considered when all the switching units of the second switching group are activated. If the switching units of the first or second switching group are associated to different portions of a seat, this arrangement results in an occupancy of the seat being only considered if the occupancy spans across the different portions of the seat. It follows that the sensor arrangement enables to discriminate between a localized occupancy of a seat, as in the case of an handbag placed on a seat, and a wider occupancy as in the case of a passenger sitting on the seat.

As the first and second switching group are connected together in order to implement a logical OR gate, an occupancy may be determined if either one of the switching groups is activated. By suitably arranging the first and second switching groups in the seat, the sensor arrangement enables an independent occupancy detection in different regions of the seat. For instance, the switching units of the first switching group may be arranged in a rear portion of the seat, when seen in forward driving direction of a vehicle, and the switching units of the second switching group in a front portion of the seat. In this case, a seat occupancy may be reliably detected if the occupancy spans across all of the switching units in the rear portion or if the occupancy spans across all of the switching units in the front portion. However an occupancy situation in which only part of the rear switching units and/or part of the front switching units are activated will not be considered as a. relevant occupancy. By suitably arranging the switching units of the different switching groups in the seat, it is thus possible to discriminate more complex seat occupancy pattern or profiles.

It should be noted that the sensor arrangement may comprise more than two switching groups, e.g. three switching groups or four switching groups or even more, which are interconnected in such a way as to implement a logical OR gate. Also each switching group may have more than two switching units, and the number of switching units per switching group may or may not be identical for each of the switching groups.

In a preferred embodiment of the invention, the at least two switching units on said first switching group and/or said at least two switching units of said second switching group are connected in series. These series connections are then connected, directly or indirectly via further electrical components, between the terminals of the sensor arrangement. Likewise the first switching group and said at least one second switching group are preferably connected, directly or indirectly via further electrical components, in parallel between said at least two terminals.

It will be noted that these arrangements enable an evaluation of the activation situation by a very simple evaluation units. In fact, if the switching units are configured as switches which establish an electrical contact when activated, a signal from the different switching units is only measureable when all the switching units of a switching group are actuated by a corresponding occupancy of the seat. Accordingly, with the proposed seat occupancy sensor, at least two switching units, which are arranged in different parts of the motor vehicle seat when the sensor is installed, are connected in a circuit in such a way that occupancy of the seat is only detected as such if all the switching units of a switching group are actuated by occupancy simultaneously. By this means, seat occupancy that is relevant to e.g. a seat belt warning system will only be recognized as such if the occupancy of the motor vehicle seat extends over a predetermined distance. Local actuation of the seat occupancy sensor, for example due to the presence of an object such as a handbag placed on the seat, will not be recognized as seat occupancy and the seat belt warning system will consequently not respond.

The connection in a circuit according to the invention of the different switching units arranged with some distance between them thus enables particularly simple detection of seat occupancy, capable of distinguishing between local and wide-area occupancy of the seat without the need for a costly matrix circuit and a costly evaluating processor unit.

In a preferred embodiment, the first switching group comprises at least n switching units, n≧3, wherein the at least one second switching group comprises at least m switching units, m≧3. In this embodiment, said sensor arrangement comprises at least one interconnection line, said interconnection line connecting a node arranged between two of said n switching units of said first switching group with at least one node arranged between two of said m switching units of said second switching group. By means of the interconnection line or lines, the sensor arrangement allows for different more complex occupancy profiles to be detected as a relevant occupancy. In fact by providing the interconnection lines at suitable nodes between switching units of the different switching groups, the switching units are electrically combined so that complex activation pattern may lead to a detectable signal at the terminals of the sensor arrangement.

It will be noted that the number of switching units per switching group may be identical for the different switching groups, i.e. n=m, or the number of switching units per switching group may be different for the different switching groups, i.e. n≠m.

In a possible configuration of such a sensor arrangement, both the first and second switching group may comprise four switching units each. The simultaneous activation of the four switching units of either of the first or second switching group will in this case be detected as a relevant occupancy. An interconnection line may be provided for connecting the node between the second and third switching unit of the first switching group to the node between the second and third switching unit of the second switching group. In that case, a simultaneous activation of the first and second switching units of the first switching group and the third and fourth switching units of the second switching group will also be detected as a relevant occupancy. It follows that the provision of the interconnection line enables the detection of more complex activation pattern.

It will be noted that in the above example, the number of switching elements and nodes connected by the interconnection line are chosen only as an example. The skilled person will unambiguously derive from this example that other configurations are possible, e.g. arrangements with more than four switching units in each switching group, with a different number of switching units in each group, arrangements where the interconnection line connects e.g. the node between the first and second switching unit of the first switching group with the node between the first and the second switching unit and/or the node between the second and the third switching unit and/or the node between the third and the fourth switching unit.

In a variant of the sensor arrangement, at least one of said switching units comprises a plurality of individually actuatable switching elements connected in parallel between two connection points of said switching unit. The effect of connecting the individual switching elements in parallel is that the switching unit is actuated as soon as a single switching element is actuated by a pressure load. If the individual switching elements are arranged in a cluster over a particular zone of the motor vehicle seat, this zone will constitute the active area of the corresponding switching unit. Occupancy of any place within this zone will thus be recognized as occupancy of the switching unit. Such a configuration of the switch units with several individual switching elements enables the extent of the zone wherein seat occupancy can be recognized to be spatially defined.

In a particularly simple embodiment, at least one of said switching units comprises a foil-type switching element. The switching units or switching elements may e.g. take the form of simple switches, such as membrane switches, for example. Such membrane switches comprise for instance a first and a second carrier foil arranged one above the other at a certain distance by means of a spacer and an electrode arrangement with at least two electrodes arranged so that an electrical contact is established between the electrodes if said first and second carrier foils are brought together in response to a pressure acting on said switching element.

In an advantageous embodiment of the invention, the switching units or switching elements may comprise foil-type pressure sensors. In this embodiment, in addition to detection of occupancy, information about the intensity of the pressure exerted can also be obtained, enabling more precise classification of the seat occupancy detected.

As already apparent from the above description, the present invention also relates to an automotive vehicle seat, comprising a seat cushion and a seat cover and a sensor arrangement as described herein above. The at least two switching units of said first switching group and at least two switching units of said second switching group are arranged at a certain distance from one another on or in a seating surface of said seat cushion.

The at least two switching units of said first switching group may be arranged in one of a front portion or rear portion of said vehicle seat when seen in driving direction of said vehicle, and the said at least two switching units of said second switching group are arranged in the respective other one of a front portion or rear portion of said vehicle seat. Alternatively the at least two switching units of said first switching group are arranged in one of a left portion or right portion of said vehicle seat when seen in driving direction of said vehicle, and the at least two switching units of said second switching group are arranged in the respective other one of a left portion or right portion of said vehicle seat.

### BRIEF DESCRIPTION OF THE DRAWINGS

A preferred embodiment of the invention will now be described, by way of example, with reference to the accompanying drawings, which show:

FIG. 1: a simplified circuit diagram of a first exemplary embodiment of a sensor arrangement in accordance with the teaching of the present invention;

FIG. 2: a possible embodiment of a switching unit;

FIGS. 3 and 4: a simplified circuit diagram of a different embodiments of a sensor arrangements with interconnection line.

### DESCRIPTION OF PREFERRED EMBODIMENTS

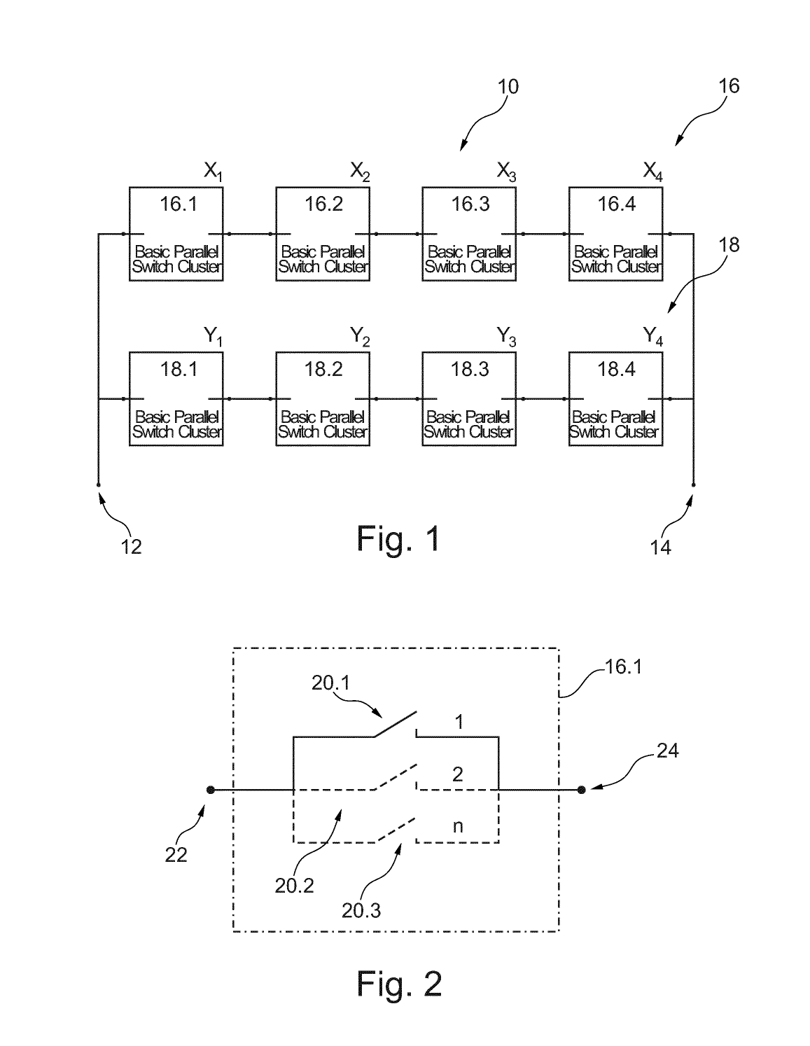

FIG. 1 shows a simplified circuit diagram of a sensor arrangement, generally references by 10, such as e.g. a seat occupancy sensor, in accordance with the teaching of the present invention. Sensor arrangement 10 comprises at least two terminals 12 and 14 for connecting the sensor assembly 10 to a (not shown) control unit. A first switching group 16 of with a number of basic switch units 16.1, 16.2, 16.3 and 16.4 is arranged and interconnected so as to implement a first logical AND gate between the terminals 12 and 14. The basic switch units 16.1, 16.2, 16.3 and 16.4 are for instance connected in series between the terminals 12 and 14.

A second switching group 18 of with a number of basic switch 18.1, 18.2, 18.3 and 18.4 is also arranged and interconnected so as to implement a first logical AND gate between the terminals 12 and 14. The basic switch units 18.1, 18.2, 18.3 and 18.4 are for instance connected in series between the terminals 12 and 14. The arrangement is such that the first switching group 16 and the second switching group 18 are connected together in such a way as to implement a logical OR gate, the first switching group 16 and the second switching group 18 may e.g. be connected in parallel between the terminals 12 and 14.

It will be noted that FIG. 1 represents only a simplified circuit diagram which shows the different switching units of each switching group arranged in a line and an overall symmetric arrangement of the different switching units. In an actual sensor arrangement, the physical arrangement of the switching units may be very different from the shown configuration. Indeed the switching units of a switching group do not need to be aligned in a vehicle seat. Also there is no requirement that the arrangement of the switching units across a seating surface follows a regular pattern or symmetry. Furthermore the sensor arrangement may comprise more than two switching groups, e.g. three switching groups or four switching groups, which are interconnected in such a way as to implement a logical OR gate. Finally the number of switching units per switching group may be different for each of the switching groups.

The switching units 16.1, 16.2, 16.3, 16.4 and/or the switching units 18.1, 18.2, 18.3 and 18.4 may comprise simple switches, which are activateable by a pressure exerted by an occupant onto a vehicle seat. Some of the switching units 16.1, 16.2, 16.3, 16.4 and/or the switching units 18.1, 18.2, 18.3 and 18.4 or all the switching units 16.1, 16.2, 16.3, 16.4 and/or the switching units 18.1, 18.2, 18.3 and 18.4 may also comprise a plurality of individually actuatable switching elements 20.1, 20.2 and 20.3 connected in parallel between two connection points 22 and 24 of the respective switching unit. Such an embodiment is represented as an example for switching unit 16.1 in FIG. 2. The skilled person will understand that the number of three switching elements for switching unit 16.1 is an arbitrary choice and that the switching unit 16.1 or any other switching unit may comprise a single switching element, two different switching elements or more than three switching elements.

The effect of connecting the individual switching elements in parallel is that the switching unit is actuated as soon as a single switching element is actuated by a pressure load. If the individual switching elements are arranged in a cluster over a particular zone of the motor vehicle seat, this zone will constitute the active area of the corresponding switching unit. Occupancy of any place within this zone will thus be recognized as occupancy of the switching unit. Such a configuration of the switch units with several individual switching elements enables the extent of the zone wherein seat occupancy can be recognized to be spatially defined.

In a particularly simple embodiment, the switching units comprise a foil-type switching element. The switching units or switching elements may e.g. take the form of simple switches, such as membrane switches, for example. Such membrane switches comprise for instance a first and a second carrier foil arranged one above the other at a certain distance by means of a spacer and an electrode arrangement with at least two electrodes arranged so that an electrical contact is established between the electrodes if said first and second carrier foils are brought together in response to a pressure acting on said switching element. In an advantageous embodiment of the invention, the switching units or switching elements may comprise foil-type pressure sensors. In this embodiment, in addition to detection of occupancy, information about the intensity of the pressure exerted can also be obtained, enabling more precise classification of the seat occupancy detected.

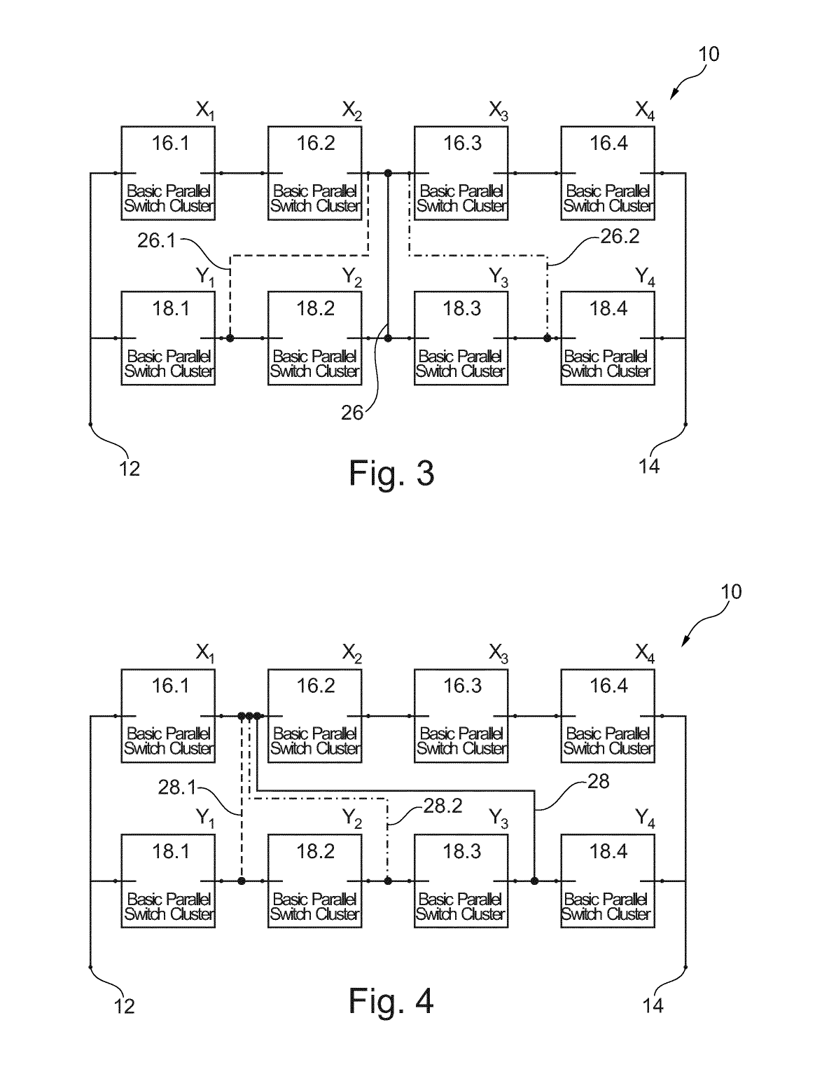

Two variants of a preferred embodiment of the sensor arrangement in accordance with the present invention are shown in FIGS. 3 and 4. In this embodiment, the sensor arrangement 10 comprises at least one interconnection line 26, 28 which connects a node arranged between two of the switching units 16.1, 16.2, 16.3, 16.4 of the first switching group 16 with at least one node arranged between two of the switching units 18.1, 18.2, 18.3 and 18.4 of said second switching group 18. By means of the interconnection line or lines, the sensor arrangement allows for different more complex occupancy profiles to be detected as a relevant occupancy. In fact by providing the interconnection lines at suitable nodes between switching units of the different switching groups, the switching units are electrically combined so that complex activation pattern may lead to a detectable signal at the terminals of the sensor arrangement.

In the embodiment shown in FIG. 3, the interconnection line 26 (shown as a solid line) connects the node between the second switching unit 16.2 and the third switching unit 16.3 with the node between the second switching unit 18.2 and the third switching unit 18.3. Other possible interconnections are shown in dashed lines as 26.1 or 26.2. In the embodiment shown in FIG. 4, the interconnection line 28 (shown as a solid line) connects the node between the first switching unit 16.1 and the second switching unit 16.2 with the node between the third switching unit 18.3 and the fourth switching unit 18.4. Other possible interconnections are shown in dashed lines as 28.1 or 28.2.

1. A sensor arrangement comprising:
at least two terminals for connecting said sensor assembly to a control unit,
a first switching group of at least n switching units, wherein n≧3 and wherein said at least n switching units of said first switching group being connected together in such a way as to implement a first logical AND gate, and
at least one second switching group of at least m switching units, wherein m≧3 and wherein said at least m switching units of said second switching group are connected together in such a way as to implement a second logical AND gate,
wherein said first switching group and said at least one second switching group are connected together in such a way as to implement a logical OR gate, and wherein said sensor arrangement comprises at least one interconnection line, said interconnection line connecting a node arranged between two of said n switching units of said first switching group with at least one node arranged between two of said m switching units of said second switching group.

2. The sensor arrangement according to claim 1, wherein said at least n switching units of said first switching group are connected in series.

3. The sensor arrangement according to claim 1, wherein said first switching group and said at least one second switching group are connected in parallel between said at least two terminals.

4. (canceled)

5. The sensor arrangement according to claim 1, wherein at least one of said switching units comprises a plurality of individually actuatable switching elements connected in parallel between two connection points of said switching unit.

6. The sensor arrangement according to claim 1, wherein at least one of said switching units comprises a foil-type switching element.

7. The sensor arrangement according to claim 1, wherein at least one of said switching units comprises a foil-type pressure sensor for converting a pressure acting on said switching unit into an electrical signal.

8. An automotive vehicle seat, comprising a seat cushion and a seat cover and a sensor arrangement according to claim 1, wherein the said at least n switching units of said first switching group and said at least m switching units of said second switching group are arranged at a certain distance from one another on or in a seating surface of said seat cushion.

9. The automotive vehicle seat according to claim 8, wherein said at least n switching units of said first switching group are arranged in one of a front portion or rear portion of said vehicle seat when seen in driving direction of said vehicle, and wherein said at least m switching units of said second switching group are arranged in the respective other one of a front portion or rear portion of said vehicle seat.

10. The automotive vehicle seat according to claim 8, wherein said at least n switching units of said first switching group are arranged in one of a left portion or right portion of said vehicle seat when seen in driving direction of said vehicle, and wherein said at least m switching units of said second switching group are arranged in the respective other one of a left portion or right portion of said vehicle seat.

11. The sensor arrangement according to claim 1, wherein said at least m switching units of said second switching group are connected in series.
